(19) United States
(12) Patent Application Publication
(10) Pub. No.: US 2005/0284275 A1
(43) Pub. Date: Dec. 29, 2005

(54) Knife for trimming plastic container

(75) Inventors: Rob Schnabel, Loganville, PA (US); Bob Stoolmaker, York, PA (US)

Correspondence Address: VENABLE LLP, P.O. BOX 34385, WASHINGTON, DC, 20045-9998, US

(73) Assignee: GRAHAM PACKAGING COMPANY, L.P., York, PA (US)

(21) Appl. No.: 10/876,479

(22) Filed: Jun. 28, 2004

(51) Int. Cl. B26D 1/14

(52) U.S. Cl. 83/469

(57) ABSTRACT

A knife for trimming comprising a circular blade adapted for attachment to a rotating flange at a point away from the center of the blade, such that said blade rotates eccentrically when said flange is rotated.

### BACKGROUND OF THE INVENTION

1. Field of the Invention

The present invention relates generally a knife, and more particularly a rotating knife for trimming a plastic container.

2. Related Art

Current knives used for trimming plastic containers have a single or dual D-shaped blade. Such blades have a point formed where the curved edge meets the straight edge. When used in a trimming operation, the point first encounters the container, piercing the plastic. As a result, there is significant wear-and-tear on the knife point(s). The chipping of the knife point leads to a reduction in the life of the knife. Further, depending on the thickness of the plastic, a particular knife would not be suitable for all cutting/trimming jobs. Additionally, the device must be very carefully positioned so that the knife point meets the plastic at each rotation and the curved portion cuts through the entire thickness of the plastic.

Since existing knives only cut at a single point, proper positioning can be tedious take a significant amount of time to complete. An improperly positioned blade can dent the container instead of cutting it. This not only damages the appearance of the container, but can also result in an ineffective seal when a lid is placed on the container, due to the gap that now exists between the container and the lid. Ultimately, the denting creates a defective product, causing a loss in productivity.

What is needed then is an improved knife, with a blade less susceptible to chipping, which lasts longer than knives that are currently available in the art. What is further needed is a knife that can penetrate plastic containers of varying thickness, without having to be meticulously positioned in order to ensure proper cutting.

### BRIEF SUMMARY OF THE INVENTION

The present invention is a rotating knife comprising a circular blade which is fixed to a base, such as a flange, at a point away from the center of the blade. For the purpose of this specification, the term knife includes the blade and any additional related components. The blade can optionally include an opening for attachment to the base. This off-center attachment results in an eccentric rotation of the blade.

This invention improves over prior art knives in having no single knife point. Rather, the invention utilizes an eccentrically rotating circular blade, which cuts along the entire blade circumference. This eliminates the problem of chipping of the knife point. The blade also allows for flexibility in positioning. In the prior art, the knife must be positioned such that the knife point meets the object to be cut. The present invention has no such positioning requirement because the blade cuts along a wider path.

This invention satisfies a long felt need for a knife used for trimming plastic that does not chip, can be used to cut plastic of varying thicknesses, and need not be strictly positioned in order to accomplish cutting.

The present invention speaks to an apparatus having a circular blade attached to a rotating flange, and a means for rotating the flange. The flange can be driven by a motor through a direct connection, or the flange also can be connected to the motor by a belt and pulley arrangement, for example. The apparatus can further include a conveyor to position an object within the rotational path of the blade. The blade, in conjunction with the flange and a rotating means, is referred to in this specification as a knife system.

In another embodiment of the invention, the apparatus utilizes a dual knife system with a second circular blade attached to a second rotatable flange at a point away from the center of the blade. The two blades are substantially parallel and can be positioned to define opposite ends of a cylinder. Alternative positions are possible and are also contemplated by the invention. Further, the apparatus can contain more than two knife systems. Additionally, the apparatus can include a conveyor for positioning a container log in the rotational path of the two blades.

The container log can be composed of a first and second container joined by a moil region and can be positioned by the conveyor such that the two containers are simultaneously separated from the moil by the two blades. Alternatively, single or multiple blades can be used to separate the two containers sequentially.

The apparatus in any of its embodiments can be used for trimming or demoiling a plastic container, and further can be used to trim or demoil containers of varying thicknesses. The term trimming as used in this specification includes separating an object from a waste portion, for example demoiling a plastic container, cutting, making an incision, and other similar actions.

The invention further speaks to a knife for trimming, including a circular blade adapted for attachment to a rotating flange at a point away from the center of the blade. Thus, the blade rotates eccentrically when the flange is rotated.

The present invention also speaks to a method for trimming or demoiling containers of varying thicknesses by eccentrically rotating a circular blade. This method can further involve attaching the blade to a rotatable flange at point away from the center of the blade, and rotating the flange to rotate the blade.

The method can also include positioning an object in the rotational path of the blade to trim an object. This object can be a plastic container or a container log comprising multiple containers, each separated by a waste portion. This method can additionally include removing the waste portion by simultaneously or sequentially separating the containers. The waste portion can further contain a moil, and the claimed method of demoiling includes separating each container from the moil.

Further objectives and advantages, as well as the structure and function of preferred embodiments will become apparent from a consideration of the description, drawings, and examples.

### BRIEF DESCRIPTION OF THE DRAWINGS

The foregoing and other features and advantages of the invention will be apparent from the following, more particular description of exemplary embodiments of the invention, as illustrated in the accompanying drawings wherein like reference numbers generally indicate identical, functionally similar, and/or structurally similar elements.

FIG. 1 depicts a top view of an exemplary embodiment of a blade according to the present invention and a plastic container;

FIG. 2 depicts a side view of an exemplary embodiment of an apparatus according to the present invention;

FIG. 3 depicts the trimming process according to an exemplary embodiment the present invention; and

FIG. 4 depicts the trimming process according an exemplary embodiment the present invention.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention. All references cited herein are incorporated by reference as if each had been individually incorporated.

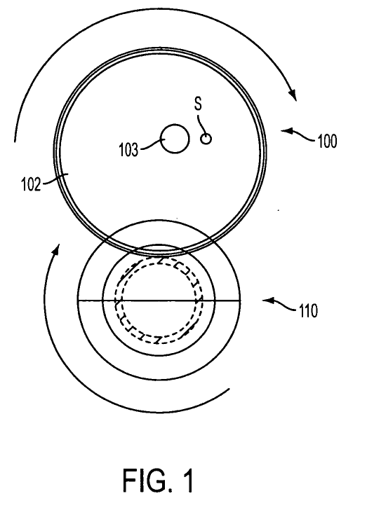

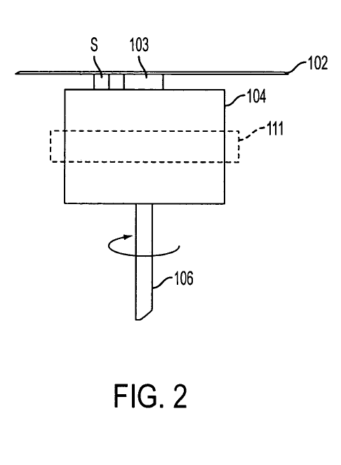

FIG. 1 depicts the knife 100 of the present invention cutting a plastic container log, 110. A container log is one or more containers with scrap or waste material attached. Typically the container log is brought into contact with the blade using a conveyor (not shown), which positions the container log 110 and knife 100 for contact throughout the trimming process. The blade 102 has an area of attachment 103 to a flange 104 (see FIG. 2). As the flange rotates, the blade pivots about the point of attachment. A locating dowel, S, is present to keep the blade and flange together and prevent slippage of the blade as it rotates.

Because the blade 102 is circular, the blade can cut into the container 110 at every point of contact. This eliminates the strict knife positioning requirement of the prior art, thus decreasing the amount of time it takes to change or mount knives in a trimmer apparatus.

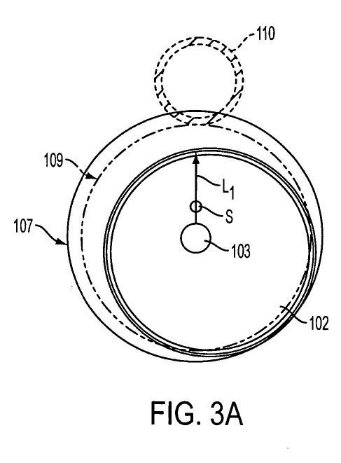

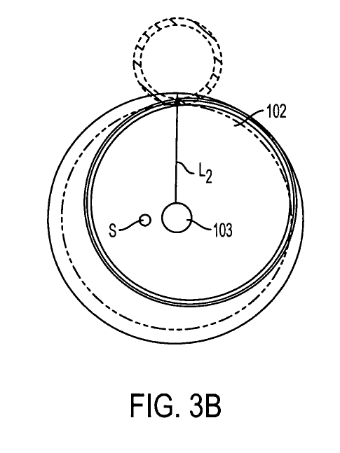

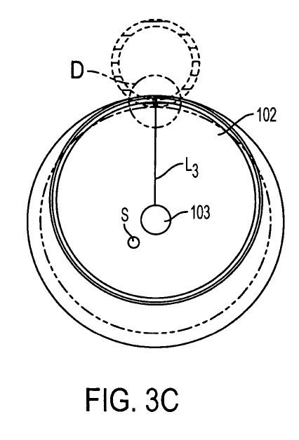

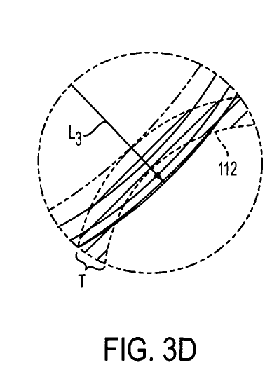

During the trimming process, the plastic object/container, 110 also rotates. This way the blade 102 does not have to penetrate through the entire container; the blade 102 need only cut through a path greater than the thickness T of the container (FIG. 3D). The knife can penetrate plastic containers of varying wall thickness because the blade is positioned off-center. Hence, the cutting path of the circular blade is greater than in the prior art, and a greater effective “knife length” can be achieved (See FIG. 3A-C).

After the container 110 has completed a minimal number of rotation cycles, the trimming process is complete, i.e., the container 110 is separated from any waste or moil portion.

In FIG. 2, the rotation of the knife blade 102 is driven by the flange 104 through its connection to a shaft 106. The shaft can be directly rotated by a motor (not shown) or the shaft 106 can be connected to the flange 104 by a belt 111. In another embodiment, the belt can be driven by the motor to turn a pulley connected to the shaft.

FIG. 3A-3C illustrate sequentially the trimming process as the plastic container, is moved into the rotational path of the blade 107. As the container 110 moves along its own rotational path 109, the container enters the rotational path of the blade 107 (FIG. 3A). However, the blade and the container are not yet in contact.

The distance between the point of attachment 103 and the rotational path of the blade defines the blade length, L₁. As a result of the blade's eccentric rotation, blade length varies and is referred to as the effective blade length. Note that in FIG. 3A, L₁ is not long enough to penetrate the container.

A conveyor is typically used to bring the knife 100 and container 110 into contact. Thus the conveyor is responsible for the positioning of the container and knife for contact throughout the trimming process.

Due to the eccentric rotation of the knife blade 102, the container 110 can be within the rotational path without being in contact with the blade itself. As the blade rotates (FIG. 3B), the container 110 contacts the blade and is trimmed. Here the effective length of the blade, L₂, is sufficient to penetrate the container 110.

Unlike prior art knives, the present knife does not have a point and therefore does not pierce the container by jabbing or stabbing, but cuts with a slicing motion. This smoothing of the initial cutting results in force being extended over a larger surface of the blade and container. As a result there is less tendency to chip the blade or cause deformation of the container.

When the container 110 is positioned for deepest penetration (FIG. 3C), the blade is fully engaged, and at its longest effective length, L₃. The blade is at its deepest penetration point, which extends beyond the inner wall 112 of the container 110. D notes the portion of FIG. 3C that is enlarged (see FIG. 3D) to more clearly show the extension of the knife through the inner wall 112 of the container 110. Because of the eccentric nature of the blade, the blade can be adjusted to move more deeply within the container, and thus can be used to trim containers with varying thicknesses. In a preferred embodiment, the plastic object is a plastic bottle that is separated from a waste portion, such as a moil.

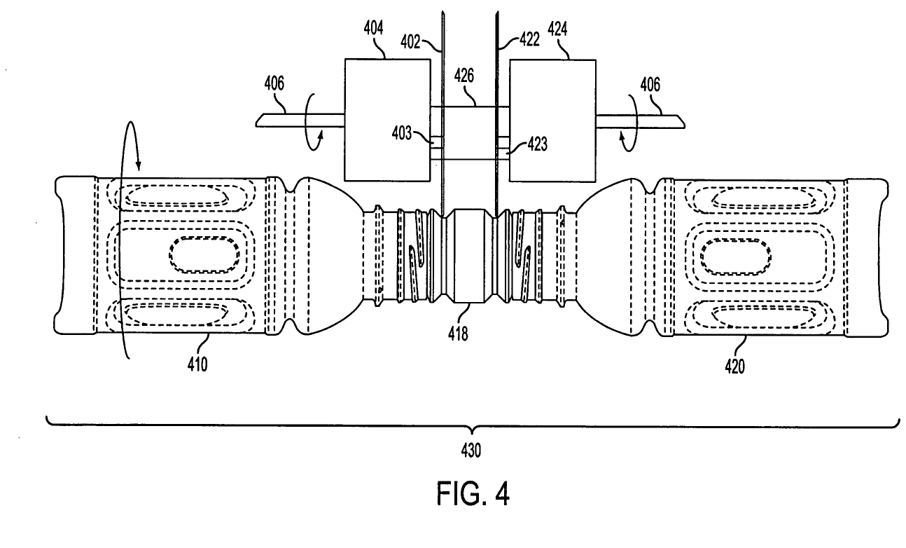

FIG. 4 illustrates an embodiment of the invention having a dual knife system. In this embodiment two knife systems are arranged in parallel and define opposite ends of a cylinder. Other parallel placements (i.e. where the knives are not directly opposite each other) are contemplated by the invention. Each knife system contains a circular blade, a flange, and means for rotating the flange to rotate the blade. The illustrated embodiment contains a first circular blade 402 attached at an off-center point 403 to a rotating flange 404, coupled to a means for rotating 406. Directly opposite the first knife system is a second knife system having a second circular blade 422 attached to a second flange 424 at an off-center point 423, where the second flange 424 is coupled to the same means for rotating 406 the flange 424 and blade 422. Alternatively, the knives can be driven by a member 426 between the blades 402 and 422. The member 426 can be rotated by, for example, a belt or other drive mechanism connected to a motor. In another embodiment, each blade flange can be coupled to a separate rotating means. In the dual-knife system depicted in FIG. 4, container log 430 includes a first container 410 and a second container 420 connected by a moil region 418. As the container log 430 approaches the rotational paths of the blades, the container log 430 rotates and continues to do so until both the first container 410 and second container 420 are each separated from the moil region 418. Using this arrangement, the first container 410 and second container 420 are separated simultaneously from the moil.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. An apparatus comprising:
a. a rotatable flange;
b. a means for rotating said flange; and
c. a circular blade attached to said flange at a point away from the center of said blade
wherein rotating said flange eccentrically rotates said blade.

2. The apparatus of claim 1 wherein the means for rotating said flange comprises a motor.

3. The apparatus of claim 2 wherein the rotating means further comprises a belt for rotatably connecting said motor to said flange.

4. The apparatus of claim 3 wherein the rotating means further comprises a pulley.

5. The apparatus of claim 1, further comprising a conveyor for positioning an object in the rotational path of said blade.

6. The apparatus of claim 1, further comprising a second rotatable flange and a second circular blade attached to said second flange which rotates about a point away from the center of said second blade, and said second blade is positioned substantially parallel to said circular blade.

7. The apparatus of claim 6, wherein said circular blade and said second circular blade are positioned to define opposite ends of a cylinder.

8. The apparatus of claim 1 further comprising a conveyor to position a container log in the rotational path of said blade and.

9. The apparatus of claim 8 wherein said container log comprises a first container and a second container joined by a moil region, and said conveyor positions said container log for simultaneously separating said first container and said second container from said moil.

10. A knife for trimming comprising a circular blade adapted for attachment to a rotating flange at a point away from the center of the blade, such that said blade rotates eccentrically when attached to the flange and the flange is rotated.

11. The knife of claim 10 adapted for trimming a plastic container.

12. The knife of claim 10 adapted for demoiling a plastic container.

13. The knife of claim 10 wherein the knife is suitable for trimming plastic containers of varying thicknesses.

14. The knife of claim 10, wherein said blade further comprises an opening for attachment to the flange.

15. A method for trimming comprising eccentrically rotating circular blade and contacting said blade with an object to be trimmed.

16. The method of claim 15 further comprising attaching said blade to a rotatable flange at point away from the center of the blade, and rotating said flange to rotate said blade.

17. The method of claim 15 wherein the blade is adapted for demoiling a plastic container.

18. The method of claim 15 further comprising positioning an object in the rotational path of said blade to trim said object.

19. The method of claim 18 wherein said object comprises a plastic container log with a waste portion.

20. The method of claim 19 wherein said waste portion comprises a moil.

21. The method of claim 20, further comprising rotating said container.

22. The method of claim 20 wherein the plastic container log comprises two separate containers joined by a moil and demoiling comprises separating each container from the moil.

23. The method of claim 15 wherein the blade is suitable for trimming plastic containers of varying thicknesses.
